(19) United States
(12) Patent Application Publication
(10) Pub. No.: US 2017/0345062 A1
(43) Pub. Date: Nov. 30, 2017

(54) COMPUTER DEVICE AND A COMPUTER IMPLEMENTED METHOD

(71) Applicant: KING.COM LIMITED, St. Julians (MT)

(72) Inventors: Richard Scarrott, London (GB); Massimo Battestini, London (GB)

(21) Appl. No.: 15/168,616

(22) Filed: May 31, 2016

(51) Int. Cl. G06Q 30/02; G06F 17/30

(52) U.S. Cl. CPC G06Q 30/0275; G06F 17/30867

(57) ABSTRACT

A computer device has an input which receives a request. The request has one or more data valued. A memory stores data defining a hierarchy of filters. The hierarchy of filters defines a plurality of different sets of filters. At least one of said filters in the hierarchy is shared by at least two of the sets and at least one filter is associated with at least two lower filters. At least one processor is configured use the data defining the hierarchy of filters to determine if said one or more data values of said request satisfy one or more of said sets of filters.

### TECHNICAL FIELD OF THE INVENTION

Some embodiments relate to a computer device and a computer implemented method and in particular but not exclusively to a computer device and computer implemented method for determining which of a plurality of sets of filters a set of data values satisfy.

### BACKGROUND OF THE INVENTION

A demand side platform (DSP) is a system that allows buyers of digital advertising inventory to manage multiple ad exchange and data exchange accounts through one interface. Real-time bidding (RTB) ad auctions for displaying online advertising takes place within ad exchanges, and by utilizing a DSP, marketers can manage their bids for advertisements placed and the pricing for the data that they display to users who make up their target audiences.

Typically, a number of different advertising campaigns may be run in parallel. Each of the different campaigns typically has a set of filters which it applies when deciding whether or not to place a bid. Processing the filters for each campaign in parallel requires a relatively large amount of processing resource.

### SUMMARY OF THE INVENTION

Some embodiments aim to provide a technical advance over the prior techniques by reducing the processing resource and/or processing time required in order to determine which one or more campaigns are to place a bid.

According to an aspect, there is provided a computer device comprising: an input configured to receive a request, the request comprising one or more data values; a memory configured to store data defining a hierarchy of filters, said hierarchy of filters defining a plurality of different sets of filters, at least one of said filters in said hierarchy being shared by at least two of said sets and at least one filter being associated with at least two lower filters; and at least one processor configured use said data defining the hierarchy of filters to determine if said one or more data values of said request satisfy one or more of said sets of filters.

The request may comprise an advertisement auction event and each of said sets of filters may define a respective advertisement campaign.

At least one processor may be configured to determine if a bid response is to be provided to said advertisement campaign in response to said determining if one or more data values of said request satisfies one or more of said sets of filters and if so to output a bid response.

The at least one processor may be configured to associate said bid response with one of said sets of filters.

The hierarchy of filters may be configured to provide for each filter a pass branch and a fail branch, wherein each of said pass branch and fail branch is associated with either a filter or a number of said sets, wherein said number comprises an integer. In some embodiments the integer comprise 1 or more.

In some embodiments, the number may options be zero if a leaf node has no campaigns associated with it. Alternatively, if a leaf node has no campaigns associated with it, the leaf node is not provided.

The hierarchy of filters may be configured to represent a tree structure, with respective filters defining nodes and one or more sets of data defining leaf nodes.

The hierarchy of filters may be such that a respective filter is provided a plurality of times and the at least one processor is configured such that only one of the respective filters is evaluated for a given request.

The hierarchy may have n or less layers, where n is the number of different filters.

For each layer only one or zero of said filters may be evaluated for a given request.

The respective filter which is provided a plurality of times may be provided in at least one of: a same layer; and different layers.

According to another aspect, there is provided a computer device comprising: an input configured to receive data defining a plurality of sets, at least two of said sets having one or more filters, said sets being used to determine if a respective request satisfies one or more of said sets of filters; and at least one processor configured to process said data defining said plurality of sets to define computer executable instructions implementing a hierarchy of filters, at least one of said filters in said hierarchy being shared by at least two of said sets and at least one filter comprising at least two lower filters.

According to another aspect, there is provided a computer implemented method, the method comprising the following implemented by at least one processor of a computer device: receiving a request, the request comprising one or more data values; and using data defining a hierarchy of filters to determine if said one or more data values of said request satisfy one or more of said sets of filters, said hierarchy of filters defining a plurality of different sets of filters, at least one of said filters in said hierarchy being shared by at least two of said sets and at least one filter being associated with at least two lower filters.

The request may comprise an advertisement auction event and each of said sets of filters may define a respective advertisement campaign.

The method may comprise determining if a bid response is to be provided to said advertisement campaign in response to said determining if one or more data values of said request satisfies one or more of said sets of filters and if so to output a bid response.

The method may comprise associating said bid response with one of said sets of filters.

The hierarchy of filters may be configured to provide for each filter a pass branch and a fail branch, wherein each of said pass branch and fail branch is associated with either a filter or a number of said sets, wherein said number comprises an integer. In some embodiments the integer comprise 1 or more.

In some embodiments, the number may options be zero if a leaf node has no campaigns associated with it. Alternatively, if a leaf node has no campaigns associated with it, the leaf node is not provided.

The hierarchy of filters may be configured to represent a tree structure, with respective filters defining nodes and one or more sets of data defining leaf nodes.

The hierarchy of filters may be such that a respective filter is provided a plurality of times and the at least one processor is configured such that only one of the respective filters is evaluated for a given request.

The hierarchy may have n or less layers, where n is the number of different filters.

For each layer only one or zero of said filters may be evaluated for a given request.

The respective filter which is provided a plurality of times may be provided in at least one of: a same layer; and different layers.

According to another aspect, there is provided a computer implemented method, the method comprising the following implemented by at least one processor of a computer device: receiving data defining a plurality of sets, at least two of said sets having one or more filters, said sets being used to determine if a respective request satisfies one or more of said sets of filters; and processing said data defining said plurality of sets to define computer executable instructions implementing a hierarchy of filters, at least one of said filters in said hierarchy being shared by at least two of said sets and at least one filter comprising at least two lower filters.

A computer readable non-transitory storage medium carrying one or more sequences of instructions which when run on at least one processor cause the process to perform the following steps: receive a request, the request comprising one or more data values; and use data defining a hierarchy of filters to determine if said one or more data values of said request satisfy one or more of said sets of filters, said hierarchy of filters defining a plurality of different sets of filters, at least one of said filters in said hierarchy being shared by at least two of said sets and at least one filter being associated with at least two lower filters.

A computer readable non-transitory storage medium carrying one or more sequences of instructions which when run on at least one processor cause the process to perform the following steps: receive data defining a plurality of sets, at least two of said sets having one or more filters, said sets being used to determine if a respective request satisfies one or more of said sets of filters; and process said data defining said plurality of sets to define computer executable instructions implementing a hierarchy of filters, at least one of said filters in said hierarchy being shared by at least two of said sets and at least one filter comprising at least two lower filters.

According to some aspects, there is provided a program product comprising a computer-readable storage device including a computer-readable program, wherein the computer-readable program when executed on a computer causes the computer to perform any one or more of the method steps described previously.

A computer program comprising program code means adapted to perform the method(s) may also be provided. The computer program may be stored and/or otherwise embodied by means of a carrier medium.

In the above, many different embodiments have been described. It should be appreciated that further embodiments may be provided by the combination of any two or more of the embodiments described above.

Various other aspects and further embodiments are also described in the following detailed description and in the attached claims.

### BRIEF DESCRIPTION OF THE DRAWINGS

FIG. 1A is a schematic of an advertising exchange system comprising a DSP.

FIG. 1B is a visual representation of an RTB auction request.

FIG. 10 shows a schematic representation of a DSP application server.

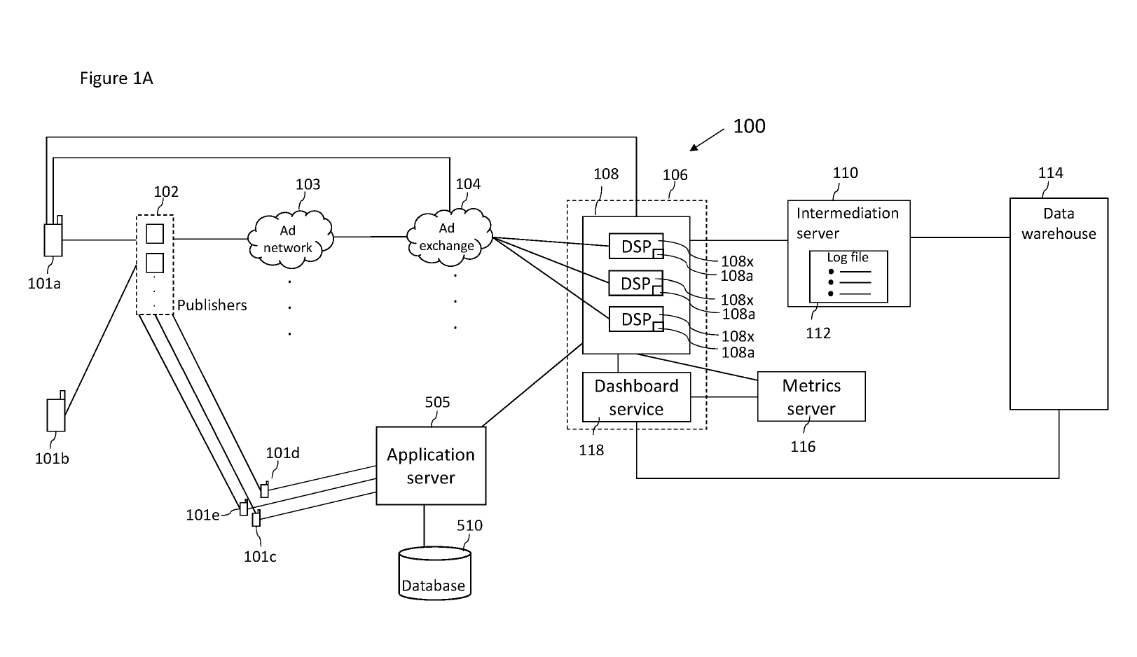

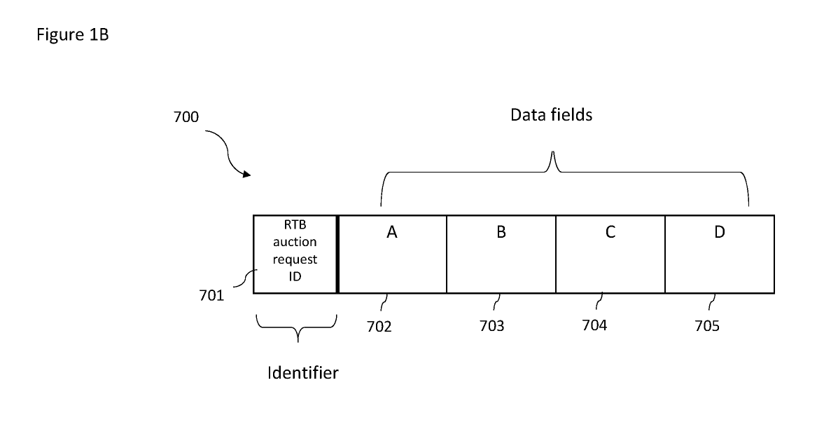

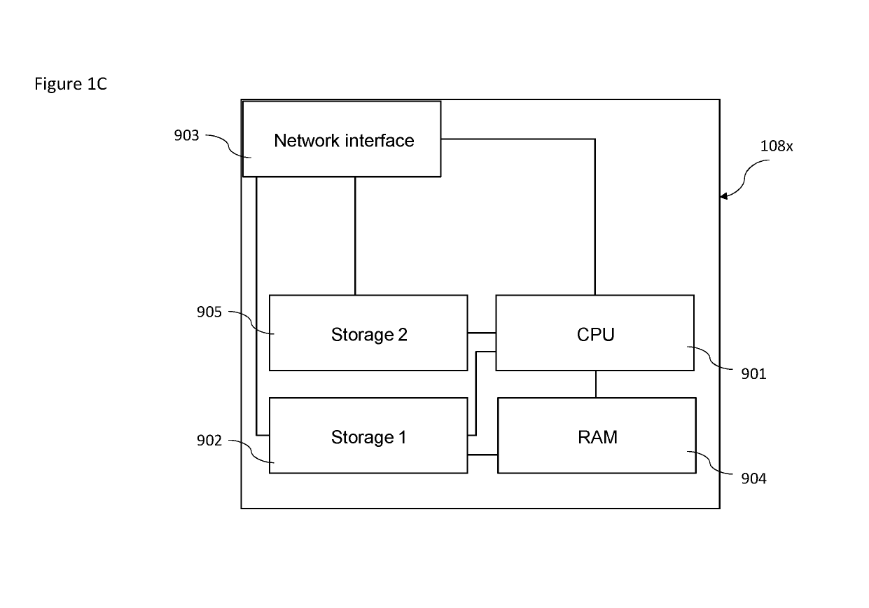

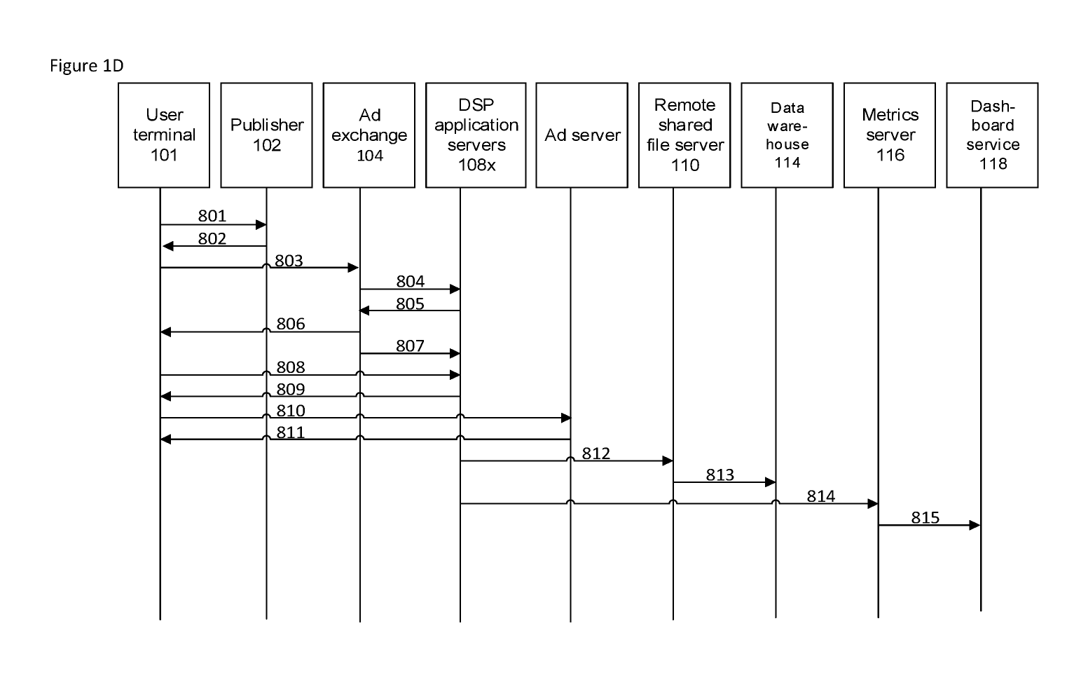

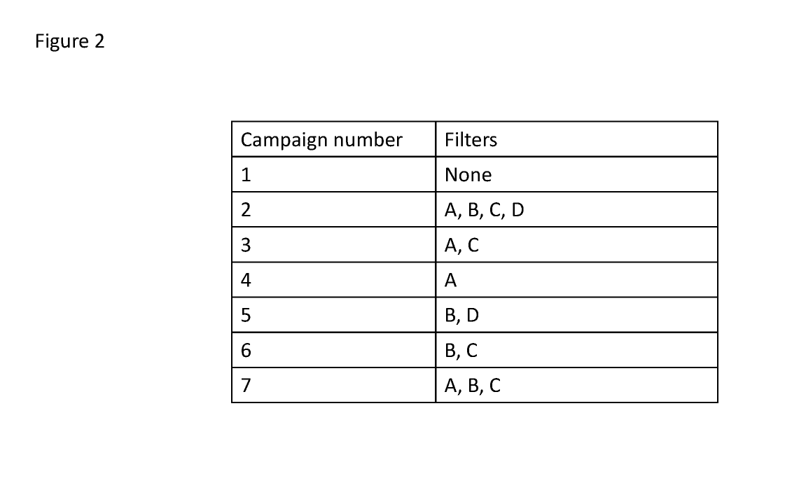

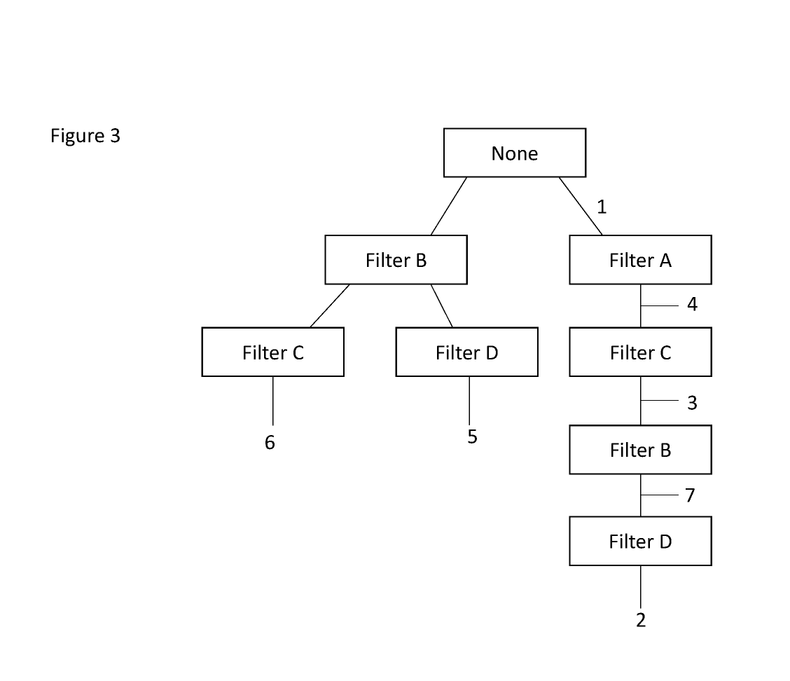

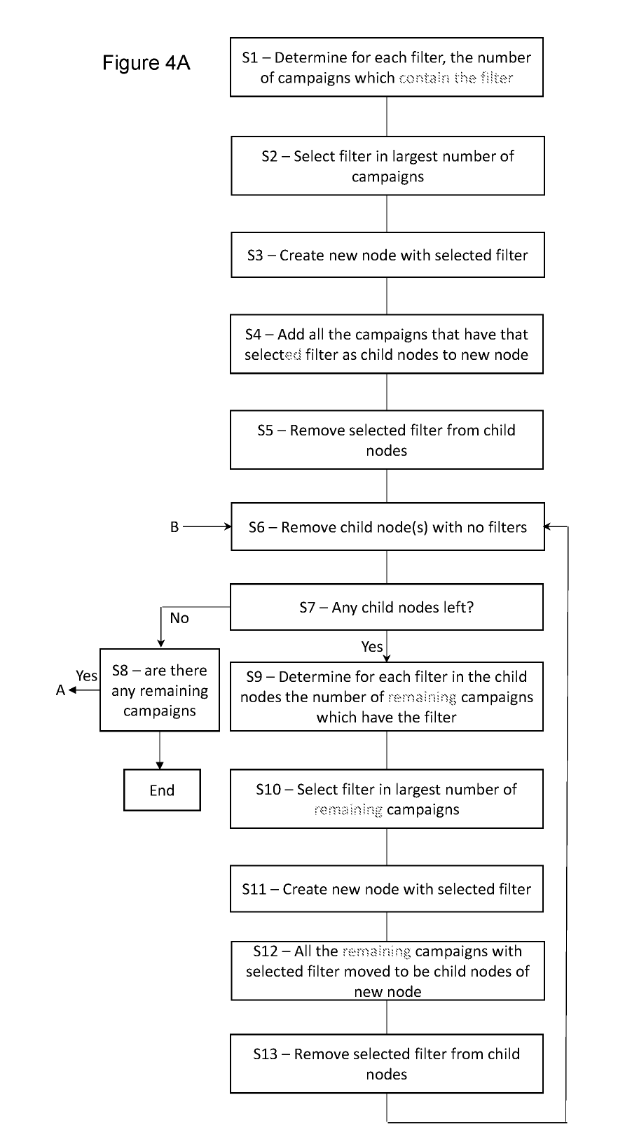

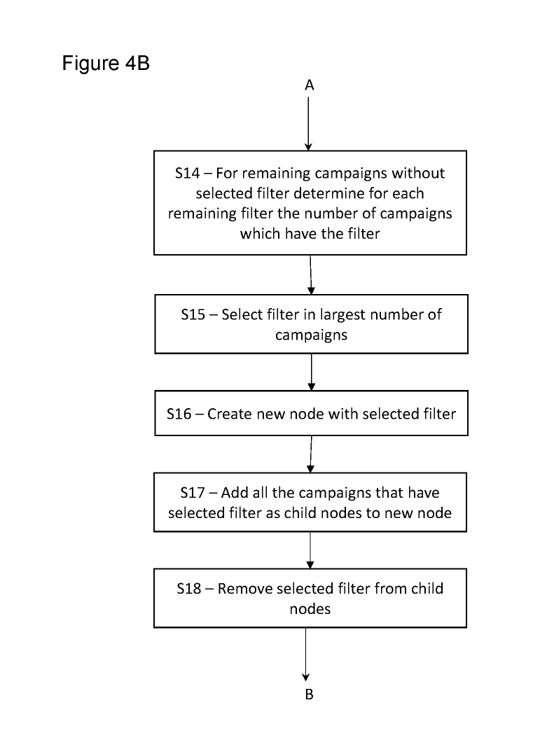

FIG. 1D shows a flow of the main data communication transfers of the system of FIG. 1A.

FIG. 2 shows schematically a number of campaigns and the associated filters.

FIG. 3 shows schematically a tree based on the data shown in FIG. 2.

FIGS. 4A and 4B show a computer implemented method for obtaining the tree information as shown in FIG. 3.

FIG. 5 shows a computer implemented method for using the tree of FIG. 3 or FIG. 6;

FIG. 6 shows schematically a second tree based on the data shown in FIG. 2; and

FIG. 7 shows a computer implemented method for obtaining the tree information as shown in FIG. 6.

### DETAILED DESCRIPTION OF THE INVENTION

The figures depict various embodiments for purposes of illustration only. One skilled in the art will readily recognize from the following discussion that alternative embodiments of the structures and methods illustrated herein may be employed without departing from the principles of the invention described herein.

FIG. 1A illustrates a system 100. In one embodiment, each of multiple user terminals 101a toe are operated to run applications. The user terminal 101 may comprise desktop computers, laptops, mobile devices, PDAs. The applications may include applets that are integrated into other applications (e.g. an Internet browser), and/or dedicated applications in their own right. The applications may comprise games, in some embodiments. However, it should be appreciated that embodiments may be used with any type of application.

In some embodiments, user terminals or user devices 101c, d and e are associated with a particular service. For example the service may be a gaming service for game applications. The game applications may be downloaded from one or more application server(s) 505 of the service and/or interact with the application servers when a game application is run on a user's user terminal 101. A game application may access the server 505 in order to communicate over the Internet (WAN) with other players of the applications associated with the gaming service, to download updates, access new content and/or store information about a player's profile and/or preferences. The devices and/or users of the gaming service may also be registered at server 505 and their details may be stored for example in a database 510 also associated with the gaming service.

The skilled person will realise that there may be many other reasons for an application to access the server(s) 505 than those mentioned. Also, although referred to as a gaming service, the particular service may be a service other than a gaming service, and the applications may be applications other than game applications.

When the user terminals 101 are connected to a wide area network (WAN) such as the internet (not shown in FIG. 1A), the applications can automatically send RTB ad calls (auction requests) via the WAN to publishers 102. The publishers 102 forward details of the requests they receive via an advertising network 103 and ad exchange server 104. The ad exchange server 104 itself then sends details of all of the received requests to multiple remote Demand Side Platforms (DSPs) 108. For convenience, FIG. 1A shows only one ad network 103 and one ad exchange 104, although the skilled person would understand that publishers can forward requests to different ad networks, and the DSP 108 can communicate with multiple ad exchanges simultaneously.

Examples of known ad exchanges include: Google™, MoPub™, Nexage™, PubMatic™, Rubicon™, and Smaato™.

FIG. 1A shows a DSP 108. The DSP 108 is located on a publicly accessible network, shown represented by the dashed line 106. In some embodiments, the DSP 108 consists of multiple, typically twenty to thirty, servers referred to hereinafter as DSP application server(s) 108x. In alternative embodiments, the DSP 108 may be implemented as part of a private network.

The DSP 108 can receive hundreds of thousands or potentially millions of ad requests from ad exchanges every second. The requests are received at a load balanced single entry point for the DSP 108 so that the requests are distributed among the multiple DSP application servers 108x. Each ad exchange 104 can connect to multiple DSP application servers 108x. Each DSP application server 108x may connect to a single ad exchange 104 at a time providing a 1:1 relationship between DSP application server 108x and ad exchanges 104. Therefore in this case it may be said that each ad exchange 104 has an independent collection of DSP application severs 108x. Alternatively, each DSP application sever 108x may connect to multiple different ad exchanges simultaneously.

Because the DSP 108 platform is load balanced, the number of DSP application servers 108x can be dynamically changed or automatically scaled based on load i.e. the volume of RTB auction requests that are received from an ad exchange. That is if the number of incoming RTB requests increases the number of DSP application servers 108x used to receive those requests can be increased accordingly in order to distribute the load. Similarly, if the number of RTB requests decreases, the number of DSP application servers 108x needed can be reduced accordingly. The load on each DSP may also be controlled so that load is evenly distributed across the DSPs.

Each RTB auction request comprises at least one identifier. In some embodiments the auction request comprises a set of data which will include an identifier which is able to identify the request. Typically the auction request will comprise a set of data.

In some embodiments, the data may comprise a cookie identifier (cookie ID) that is unique to a user and is associated with the ad exchange 104.

The set of data that makes up an RTB auction request may be sourced from one or more locations e.g. data store(s) (not shown in FIG. 1a). The set of data included in an RTB auction request may further comprise various different data fields, for example but not limited to one or more user identifiers, the user's geographic location, the user's preferred language, an identifier for the application the RTB auction request has come from (e.g. a type of game).

FIG. 1B shows an example of a single RTB auction request that is recorded by a DSP application server 108x as an auction “event”. In this example, the auction request is shown as a data stream 700 headed by an RTB auction request identifier 701. The stream also includes a sequence of different data fields shown represented as A 702, B 703, C 704 and D 705. The person skilled in the art will appreciate that in embodiments, an RTB request may comprise more or fewer data fields than those shown in FIG. 1B.

It should be noted that any one or more of the data fields (e.g. A, B, C or D) may be left empty, if for example there is no corresponding data currently available for the respective data field. Also, the user of the user terminal 101 can select to opt out of having one or more of the data fields being accessible by the DSP 108. In either of these cases, auction events can still be recorded but without including one or more of the data fields.

The DSP application servers 108x may be configured to filter the RTB requests based on one or more of the available data fields of the RTB auction requests. This will be described in more detail later.

For example a DSP application server 108x may determine from the data fields a type of game that a user is playing. This information can be used to select an advert for a similar type of game that the user may be interested in playing.

The data fields may be filtered based on user ID so that the DSP application server 108x does not place bids too frequently in response to the received RTB auction requests. In this way the user is not constantly bombarded by advertisements. Similarly, filtering based on user ID can be useful so that the DSP application server 108x does not keep selecting the same ad content for a user.

As another example embodiment the data fields may be filtered by the user's language to ensure that adverts with content in the correct language (i.e. in the user's language) are selected and placed for that user.

For each request seen by a DSP server 108x, the DSP application server 108x must decide on behalf of an advertiser it is representing whether or not to make a bid for that opportunity to place an ad so that it is presented in the user's application. If a bid is placed, the DSP application server 108x sends the bid to the ad exchange 104 which processes the bids from other competitors that have also received the same advertising request. As with the RTB auction requests, each auction bid placed by the DSP application servers 108x includes one or more bid-specific identifiers. Each bid also includes the associated one or more auction request identifiers described above, so that every bid is linked to a corresponding RTB auction request.

The DSP application server 108x that places the winning bid (usually based on the highest price bid) is informed of the win by the ad exchange 104. Each win includes one or more win-specific identifiers. Each win also includes the associated one or more auction request identifiers and optionally the bid-specific identifier(s) as well, so that every win is at least linked to a corresponding RTB auction request. The winning advertiser thus gets their ad published to the user's application, usually in the form of a banner or a full page shown displayed on the user terminal 101 screen. The bids that are made may be part of a “second price auction” such that the advertiser that wins the auction actually ends up paying the second highest price bid for placing the ad in the user's application. Alternatively, the auction and the bids thereof can be of any suitable type of electronic auction as is known in the art.

Each of the DSP application servers 108x listen to all of the RTB requests they receive form the ad exchange.

In embodiments the server(s) 505 are associated with the proprietor of the DSP 108, meaning that it can be in that proprietor's interests to monitor the data of auction events (requests, bid responses and wins) specifically in relation to the users that are playing a game for example. For example, by assessing the identifiers of the auction event data recorded by the DSP 108 (e.g. from the records stored by the DSP application servers 108x and/or from the log file data imported into a data warehouse 114), the DSP 108 can use this information to retarget appropriate ads for a user, as described above. For instance ads may be retargeted to certain ones of the devices and/or users of a subgroup. As mentioned above, based on one or more of the data fields of recorded event data, appropriate ad(s) can be selected for users e.g. based on a type of game the user is playing and/or the user's language. The skilled person will understand that there will be many other ways of using the event data information and identifiers for retargeting ads to specific devices and/or users.

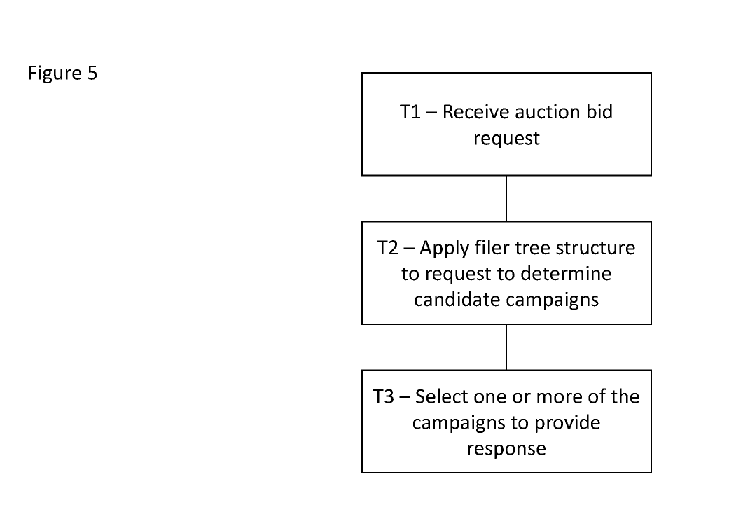

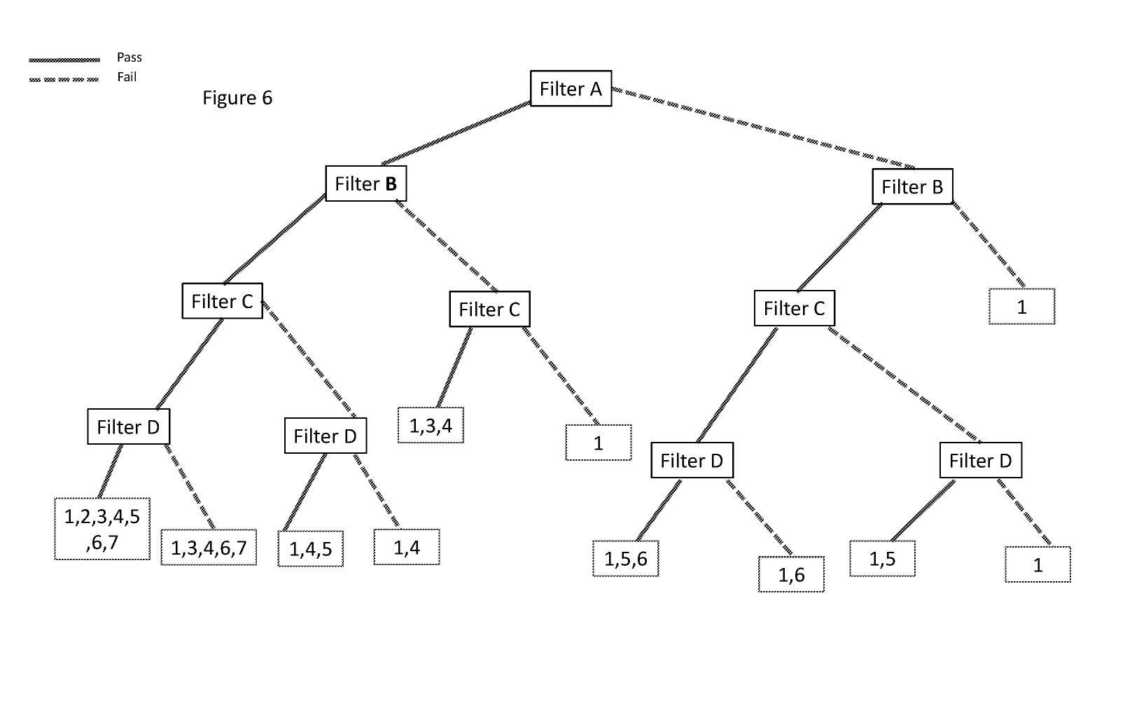

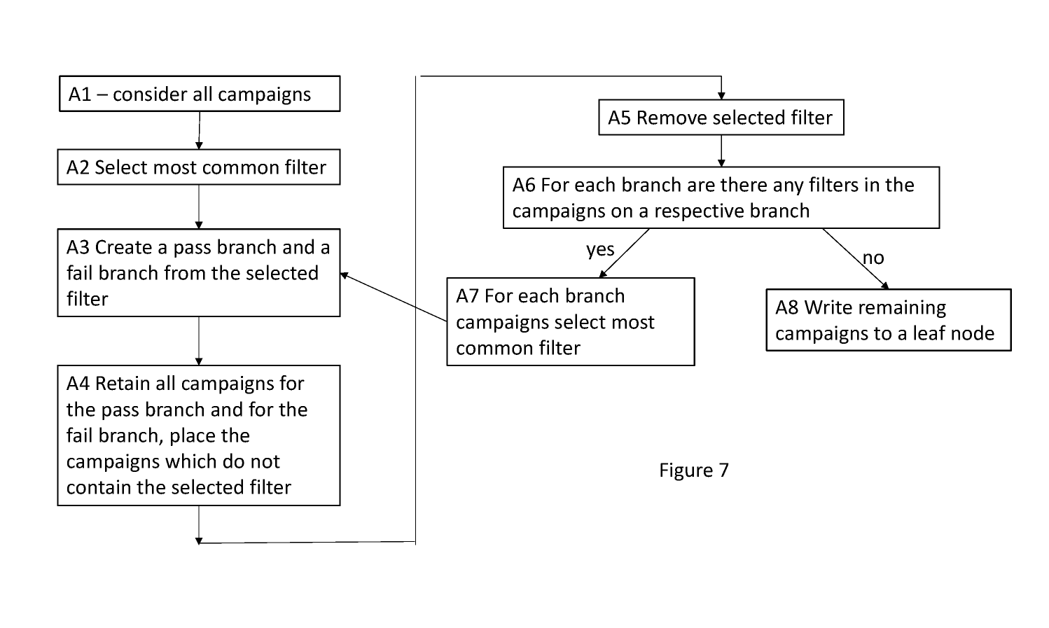

Each of the DSP application servers 108x have an associated software agent 108a running on a processor 901 (see FIG. 10) of the respective DSP application server 108x. The software agent 108a collects the metrics from the DSP application server 108x that it is running on. The collected metrics for all of the DSP application servers 108x are aggregated and stored in a metrics server 116.

The metrics data stored in metrics server 116 is accessible by a dashboard service 118 running on a computing device (not shown in FIG. 1).

Each of the DSP application servers 108x export their recorded event data to a third party remote shared file server 110, also known as an intermediation server, and located outside of the cloud 106, upon expiry of a predefined time interval. The remote shared server stores log file data 112. For example each of the DSP application servers 108x is configured to export their recorded event data every hour. Other time intervals may be defined for the DSP application servers 108x to export their recorded data.

Referring to FIG. 10, an example schematic representation of a DSP application server 108x is shown. The DSP application server 108x comprises one or more central processing unit(s) (CPU) 901 for performing the processes of the DSP application server 108x as described throughout the present disclosure. The CPU 901 is connected to a first local memory store 902 that stores software instructions which are run by the CPU 901. The software instructions include the instructions required by the CPU 901 to perform the steps of sampling the received auction requests and filtering the data fields of the RTB auction requests. The software instructions also enable a network interface or port 903 to send and receive messages and data, for example over the WAN, to and from the various other entities the DSP application server 108x communicates with e.g. the user terminals 101, ad exchanges 104, dashboard service 118, metrics server 116, remote shared file server 110, application server 505 and database 510.

The DSP application server 108x also comprises Random Access Memory (RAM) 904 that loads the software instructions to be run on the CPU 901. When the software is run by the CPU 901 this forms the software agent 108a as depicted running on DSP application server 108x in FIG. 1A. The DSP application server 108x also comprises a second local memory store 905 that temporarily stores the auction events data prior to exporting them to the remote shared file server 110. Alternatively, the DSP application server 108x may only have a single memory store, e.g. local memory 902, which can be shared or split between both the stored software and the stored auction events data. The incoming set of data making up an RTB auction request is received at the network interface 903. The CPU 901 processes the received data, and compiles it into an auction request event which is stored in the local memory store (i.e. 902 or 905). The CPU 901 can also be configured so that it performs the step of exporting the stored event data to the remote shared file server 110 upon expiry of a programmable time interval.

In embodiments, a plurality of different campaigns are supported. The campaign can be regarded as a logical grouping of a bidder and a set of zero or more filters. There may, in some embodiments be other configurations details such as creative elements or the like. A campaign can be regarded as a set of data which includes information as to what filters are to be applied to a received request.

At run time, the bidder associated with a given campaign will only be offered the opportunity to bid as part of that campaign if all of the associated filters applied to the inbound bid request are satisfied. The filters can be any suitable filters and for example may be a country filter, a device filter, a type of network of filter, a gender filter and/or any other suitable filter.

To assist in understanding, FIG. 2 shows an example of 7 campaigns each with different filters. Typically, all of those campaigns will belong to a single bidder. In the example shown, the first campaign has no filter. The second campaign has the filters A, B, C and D. The third campaign has the filters A and C. The fourth campaign has only the filter A. The fifth filter has the filters B and D. The sixth filter has the filters B and C. The seventh filter has the filters A, B and C.

Each filter can be regarded as being either true (allow the bid) or false (do not bid). In the case of for example campaign 2, a bid can only be placed if filters A, B, C and D are all true.

Currently each time an RTB auction request is received, each campaign will individually apply their filters to see whether or not a bid response should be made for that campaign. Since the filters are tested individually from each campaign, the worst-case number of filtering operations performed is 14. The best case is two as far as campaigns 2 to 7 are concerned, assuming that each campaigns is excluded by its first filter. The average number of filtering operations performed for campaigns 2 to 7 will be somewhere between 2 and 14.

In embodiments, the evaluation of the campaign filters across multiple campaigns can be optimised by constructing at load time and on subsequent changes to one or more campaigns, a logic tree which is used to process a received RTB auction request. In the tree, campaigns have a parent node which also has the filter associated with that parent node. If the parent node filter evaluates to false, none of the child nodes of that parent node are evaluated.

Reference is made to FIG. 3 which schematically shows such a tree for the campaigns of FIG. 2. The first node is marked none. This is where no filter is applied. This is used by campaign 1. The first node has two child nodes, one associated with filter A and one associated with filter B.

Referring first to the first child node which has filter A applied to it, this will be the parent node associated with campaigns 2, 3, 4 and 7. If a RTB auction request passes this filter, then that request may be responded to by campaign 4 and passed to the child node, filter C. If a RTB auction request does not pass filter A, then it would not be considered by any of the child nodes of filter A. As mentioned if the RTB auction request passes filter A, it would then be passed to the next child node which would be filter C. If the RTB auction request passes filter C, then that request may be responded to by campaign 3 and passed to the child node, filter B. If a RTB auction request does not pass filter B, then it would not be considered by any of the child nodes of filter B. As mentioned if the RTB auction request passes filter B, it would then be passed to the next child node which would be filter D. If the RTB auction request passes filter B, then that request may be responded to by campaign 7 and passed to the child node, filter D. If the RTB auction request passes filter D, then that request may be responded to by campaign 2. There are no further child nodes.

As mentioned already, there is a filter B node. If the RTB auction request passes filter B, then that request is passed to both of the child nodes, filter C and filter D. If the RTB auction request passes filter C, then that request may be responded to by campaign 6. There are no further child nodes. If the RTB auction request passes filter D, then that request may be responded to by campaign 5. Again, there are no further child nodes.

As can be seen, the worst number of filtering operations is 7 and the best case is 2.

It should be appreciated that the shown example has a relatively small number of campaigns. In some actual deployments, the number of campaigns may be very much greater, for example of the order of tens or even hundreds of campaigns.

Take an example with 40 campaigns all requiring the same filter for example for targeting the USA. Each of these campaigns also has its own unique filter and half of them also require the device to be a first type whilst the other half require the device to be a second type of device. In this case, the worst case filter operation count is 120 (40 USA+40 device+40 unique). The best case would occur when the device is not in the US requiring only 40 filtering operation. Using the tree case, the best case is one filtering operation where the device is not in the USA and the worst case would be would be 43 (1 (US)+2 (2 devices)+40 (unique filters)).

As can be seen, the number of filtering operations required for a given bid request may be dramatically reduced as compared to the prior approach.

In embodiments, the optimised tree structure is internal to the system and may not be exposed to the user. The user is able to continue to view the list of what appears to be independent campaigns. Thus, the user is able to select with freedom the exact campaign they want without any concerns about which filters to use.

Reference is made to FIGS. 4A and 4B which show a computer implemented method. The method may be performed by the DSP server or other computer device.

In step S1, for each filter, the number of campaigns which has that filter is determined. Going back to the schematic example of FIG. 2, it is determined how many campaigns have filter A, how many campaigns have filter B, how many campaigns have filter C and how many campaigns have filter D. In the simple example shown, four campaigns have filter A, 4 campaigns have filter B, 4 campaigns have filter C and 2 campaigns have filter D.

In step S2, the filter which applies to the largest number of campaigns is selected. Where there are two or more filters having the same number which is the largest number of campaigns, one of those filters is selected using any suitable criteria. This will be discussed later. In the example shown, filter A is selected.

In step S3, a new node is created with the selected filter. A new node is created with the selected filter. Going to the example illustrated in FIG. 3 and this will be the node with the selected filter A.

In step S4, all of the campaigns that have that selected filter (filter A) are added as child nodes to the new node. (FIG. 3 shows the final tree.) In this example, filter A would have a child node for campaigns 2, 3, 4, and 7.

In step S5, the selected filter (filter A) is removed from each of the child nodes. This would leave a child node for campaign 2 having filters B, C and D, a child node for campaign 3 having filter C, a child node for campaign 4 with no filter and a child node for campaign 7 having the filter C.

In step S6, any child nodes which have no filter are removed. In this case, the child node for campaign 4 is removed.

In step S7, it is determined if there are any child nodes left. If not, the method goes to step S8 and if so, the method goes to step S9. The branch that goes to step S9 will first be described.

The next step is thus step S9 if there are one or more child nodes left. It is determined for each filter in the child nodes the number of campaigns which have each filter. In the example shown, there are three campaigns which have filter C, two campaigns which have filter B and one campaign which has filter D.

In step S10, the filter which is in the largest number of campaigns is selected. In this example, filter C is selected. If there are more than one filter in the same number of campaigns, one of those filters is selected using any suitable criteria.

In step S11, a new node is created with the selected filter, filter C. This will be a child node to the previous filter node, filter A.

In step S12, all of the campaigns with the selected filter are moved to be child nodes of the new node. In other words, filter C becomes the child node of filter A and filter C has child nodes for campaigns 2, 3 and 7.

In step S13, the selected filter is removed from the child nodes. Accordingly, the child node for campaign 2 will have filters B, and D, the child node for campaign 3 will have no filters and the child node for campaign 7 will have filter B. The method will then loop back to step S6.

Going back to step S7, if there are no child nodes, then the next step is step S8, where it is determined if there are any unprocessed campaigns. An unprocessed campaign is one where there the campaign has not been fully broken down into the tree structure. If not, the method ends and the tree structure has been completed. If there is still one or more unprocessed campaign, then the next step is step S14 of FIG. 4B. The reference A is used to show the relationship between the flow of FIGS. 4A and 4B. The method of FIG. 4B may be at least partially executed in parallel with that of FIG. 4A.

Reference is now made to FIG. 4B. In step S14, for the remaining campaigns without the selected filter, it is determined for each filter the number of campaigns which have the respective filter. In this case, this is campaigns 5 and 6.

In step S15, the filter which is in the largest number of campaigns is selected. In this case, there are two campaigns with filter B, one campaign with filter D and one campaign with filter C. Accordingly filter B is selected. If there are more than one filter in the same number of campaigns, one of those filters is selected using any suitable criteria.

In step S16, a new node is created with the selected filter, filter B.

In step S17, all of the campaigns with the selected filter are moved to be child nodes of the new node. In other words, filter B has child nodes for 5 and 6.

In step S18, the selected filter is removed from the child nodes. Thus, the child node will have filter D in the case of campaign 5 and filter C in the case of campaign 6. As indicated by reference B, the next step will be step S6.

The method is iterated until a tree structure shown in FIG. 3 is produced. It should be appreciated that the tree structure as shown in FIG. 3 may be stored and used in any suitable form. For example computer executable code may be generated and stored. When that computer executable code is run, the functionality represented by the tree may be applied to each RTB auction request. Depending on which filters are passed (if any) will depend on which campaigns will bid on a campaign.

Reference is made to FIG. 6 which shows an alternative tree structure based on the data shown in FIG. 2. The first node in the arrangement of FIG. 6 is filter A. This filter is selected as it is present in the most number of campaigns.

When an RTB auction request is received, it is checked to see whether or not filter A is passed or not. If the filter is passed, then the next filter is filter B. Filter B is again selected as being the filter of the remaining number of filters present in the most number of campaigns. Again, filter B can be passed or not. If filter B is passed, then the next filter is filter C. Filter C can be passed or not. If the filter C is passed, then the next filter is filter D. Filter D may be passed or not.

Leaf nodes are provided at the end of each branch. If filter D is passed, the leaf at the end of this branch comprises campaigns 1, 2, 3, 4, 5, 6 and 7. These represent all the campaigns eligible to bid on a request.

In the case that filter D is not passed, the leaf node will comprise campaigns 1, 3, 4, 6 and 7.

It should be appreciated in the example given in FIG. 2 a bid can be placed if filters in addition to the required filters are present. Take the example of campaign 5 which has filters B and D. Provided the bid request satisfies filters B and D, a bid may be made, regardless of whether or not filters A and D are satisfied or not.

Going back to filter B in the case where a request has passed filter A but does not pass filter B, in this case, the next filter is filter C. Filter C can be passed in which case the leaf node will comprise campaigns 1, 3 and 4. Likewise, filter C may not be passed in which case the leaf node will comprise campaign 1.

In the event that filter A and B have both been passed and filter C is not passed, then the next node will be filter D. If filter D is passed, then the leaf node comprises campaigns 1, 4 and 5. If filter D is not passed, then the leaf node will comprise campaigns 1 and 4.

The part of the tree where filter A is not passed will now be described. In this case, the next filter is filter B. If filter B is not passed, then the leaf node comprises campaign 1. If filter B is passed, then the next filter is filter C. If filter C is passed, then the next filter will be filter D. If filter D is passed, then the leaf node comprise campaigns 1, 5 and 6. If filter D is not passed, then the leaf node comprises campaigns 1 and 6. Going back to filter C, if filter C is not passed, then the next node will be filter D. The filter D is passed, then the leaf node comprises campaigns 1 and 5. If filter D is not passed, then the leaf node comprises campaign 1.

Thus, with this tree, for a bid request which is received, that bid request needs to go through at least two filters and at most four filters.

Reference is made to FIG. 7 which show a computer implemented method for providing the tree structure of FIG. 6. The method may be performed by the DSP server or other computer device.

In step A1, for each filter, the number of campaigns which has that filter is determined. Going back to the schematic example of FIG. 2, it is determined how many campaigns have filter A, how many campaigns have filter B, how many campaigns have filter C and how many campaigns have filter D. In the simple example shown, four campaigns have filter A, 4 campaigns have filter B, 4 campaigns have filter C and 2 campaigns have filter D.

In step A2, the filter which applies to the largest number of campaigns is selected. Where there are two or more filters having the same number which is the largest number of campaigns, one of those filters is selected using any suitable criteria. In the example shown, filter A is selected.

In step A3, a node is created with the selected filter along with a pass branch and a fail branch. A pass branch is for when a request satisfies the filter and a fail branch is for when a request does not satisfy the branch.

In step A4, all of the campaigns are retained for the pass branch. For the fail branch, only the campaigns which do not have the selected filter are retained. For example, campaigns 1, 2, 3, 4, 5, 6 and 7 are retained for the pass branch and campaigns 1, 5 and 6 for the fail branch.

In step A5, the selected filter (filter A) is removed.

In step A6, it is determined for each branch if there are any filters in the campaigns on the respective branch. If so, the next step is step A7. In step A7 for each branch, the most common filter in the campaigns remaining in that branch is selected. The next step is then step A3.

If not, the next step is step A8. In step A8, the remaining campaigns are written to a leaf node.

The method is iterated until a tree structure shown in FIG. 6 is produced. It should be appreciated that the tree structure as shown in FIG. 6 may be stored and used in any suitable form. For example computer executable code may be generated and stored. When that computer executable code is run, the functionality represented by the tree may be applied to each RTB auction request.

With this arrangement, each filter will only run at most once. This gives a worse case of 4 filter executions. To generalise, the most number of executions required is n where n is the number of different filters.

When a bid request arrives this tree will be navigated by executing the first filter on the request and chasing the pass or fail branch. The same will be done with the next filter and so on until a leaf node is reached. The campaigns in the leaf node are all the campaigns eligible to bid on the request and they have been determined in a minimum number of steps.

Reference is made to FIG. 5 which shows a method which uses the tree structure of FIG. 3 or 6 or the code which implements the tree structure as described previously.

In step T1, the auction bid request is received.

In step T2, the filter tree structure is applied to the request to determine candidate campaigns.

In step T3, one or more of the campaigns are selected to provide a bid response.

In the described embodiments, a filter which applies to most campaigns is selected in preference to other filters. However, in different embodiments, different criteria could be used when selecting a filter. For example, each filter could be assigned a weight and that is used when determining which filter to select. For example, a weight may take into account the likelihood that a filter is to be passed. Additionally or alternatively, the relative costs associated with a filter may be used. In some embodiments, two were more factors may be used when selecting a filter. For example, a weight of a filter and the frequency of the filter may be used together to determine which filter is selected.

As mentioned previously, in some embodiments there may be a situation where there are two or more filters each of which appear the same number of times. The filter which is selected may be done on the basis of a random selection. For example, each filter could be assigned a weight and that is used when determining which filter to select. For example, a weight may take into account the likelihood that a filter is to be passed. Additionally or alternatively, the relative costs associated with a filter may be used. In some embodiments, two or more factors may be used when selecting a filter. For example, a weight of a filter and the frequency of the filter may be used together to determine which filter is selected.

In some embodiments, hierarchical information may be used. For example, country information may have a higher hierarchical position as compared to device information which in turn may have a higher hierarchical over app information. However, it should be appreciated that this example of hierarchy is only one example and different embodiments may use different hierarchical information.

FIG. 1D depicts a visual flow of the main data communication transfer steps performed by the system 100.

At step S801, a user of the user terminal 101 uses an installed web browser or application to navigate to a website or access a service associated with a publisher 102.

At step 802, a publisher web server sends back code, usually in the form of HTML code although other code language types may be used. The code returned to the browser (or application) indicates a publisher ad server that the browser can access to download a further HTML code comprising a coded link known as an ad tag. The ad tag points the user terminal to the RTB enabled ad exchange 104 and causes the user terminal 101 to pass on information about the publisher's ID, the site ID and ad slot dimensions when an ad request is made.

At step 803 an RTB request for bid (RFB) is generated by a processor of the user terminal 101 and sent directly over the WAN to the ad exchange 104.

At step 804 the ad exchange commences the RTB auction procedure by forwarding the received requests to the DSP application servers 108x.

The DSP application servers 108x use the retrieved user data information and the publisher information in the originally received auction request and the tree structure of FIG. 3 to determine whether to place a bid (bid response). The bid data comprises one or more of the associated auction request identifiers plus bid-specific identifiers as described above. The bid also includes a DSP redirect for the user terminal 101, should the bid win the RTB auction. The bid data is communicated by the DSP application server 108x back to the ad exchange 104 (step 805).

At step 806 the ad exchange 104 selects the winning bid and passes the DSP redirect to the user terminal 101 associated with the winning bid. The DSP application server 108x is also informed of the win where a win event is recorded (step 807). The win event includes one or more win-specific identifiers plus the associated one or more auction request identifiers, and optionally the bid-specific identifier(s) as well.

At step 808 the user terminal 101 directly calls the DSP 108 using the DSP redirect received at step 806.

By return the DSP 108 sends to the user terminal 101 details of the winning advertiser's ad server by way of an ad server redirect at step 809. The user terminal 101 uses the ad server redirect to call the ad server at step 810, and in response the ad server serves the final advertisement (e.g. banner, window, full screen ad) for presentation in the bowser (or application) at the user terminal 101 at step 811.

At step 812, the DSP application servers 108x routinely export the event data to the remote shared file server 110.

In turn, at step 813, the data warehouse 114 is configured to import a log file 112 of event data from the remote shared file server 110.

In parallel with the steps of recording the auction activities as auction events, the DSP application servers 108x collect metrics for all of the observed auction activities and stores them in metrics server 116 (step 814).

After metrics data has been stored at the metrics server 116, the dashboard service 118 accesses the stored metrics from metrics server 116 at step 815. The dashboard service 118 processes the retrieved metrics data.

The person skilled in the art will realise that the different approaches to implementing the methods, devices and system disclosed are not exhaustive, and what is described herein are certain embodiments. It is possible to implement the above in a number of variations without departing from the spirit or scope of the invention.

1. A computer device comprising:
an input configured to receive a request, the request comprising one or more data values;
a memory configured to store data defining a hierarchy of filters, said hierarchy of filters defining a plurality of different sets of filters, at least one of said filters in said hierarchy being shared by at least two of said sets and at least one filter being associated with at least two lower filters; and
at least one processor configured to use said data defining the hierarchy of filters to determine if said one or more data values of said request satisfy one or more of said sets of filters.

2. A computer device as claimed in claim 1, wherein said request comprises an advertisement auction event and each of said sets of filters defines a respective advertisement campaign.

3. A computer device as claimed in claim 2, wherein said at least one processor is configured to determine if a bid response is to be provided to said advertisement campaign in response to said determining if one or more data values of said request satisfies one or more of said sets of filters and if so to output a bid response.

4. A computer device as claimed in claim 3, wherein said at least one processor is configured to associate said bid response with one of said sets of filters.

5. A computer device as claimed in claim 1, wherein said hierarchy of filters is configured to provide for each filter a pass branch and a fail branch, wherein each of said pass branch and fail branch is associated with either a filter or a number of said sets, wherein said number comprises an integer.

6. A computer device as claimed in claim 1, wherein said hierarchy of filters is configured to represent a tree structure, with respective filters defining nodes and one or more sets of data defining leaf nodes.

7. A computer device as claimed in claim 1, wherein said hierarchy of filters is such that a respective filter is provided a plurality of times and the at least one processor is configured such that only one of the respective filters is evaluated for a given request.

8. A computer device as claimed in claim 7, wherein said hierarchy has n or less layers, where n is the number of different filters.

9. A computer device as claimed in claim 8, wherein for each layer only one or zero of said filters is evaluated for a given request.

10. A computer device as claimed in claim 7, wherein said respective filter which is provided a plurality of times is provided in at least one of: a same layer; and different layers.

11. A computer device comprising:
an input configured to receive data defining a plurality of sets, at least two of said sets having one or more filters, said sets being used to determine if a respective request satisfies one or more of said sets of filters; and
at least one processor configured to process said data defining said plurality of sets to define computer executable instructions implementing a hierarchy of filters, at least one of said filters in said hierarchy being shared by at least two of said sets and at least one filter comprising at least two lower filters.

12. A computer implemented method, the method comprising the following implemented by at least one processor of a computer device:
receiving a request, the request comprising one or more data values; and
using data defining a hierarchy of filters to determine if said one or more data values of said request satisfy one or more of said sets of filters, said hierarchy of filters defining a plurality of different sets of filters, at least one of said filters in said hierarchy being shared by at least two of said sets and at least one filter being associated with at least two lower filters.

13. The computer implemented method of claim 12, wherein said requests comprises an advertisement auction event and each of said sets of filters may define a respective advertisement campaign.

14. The computer implemented method of claim 13, comprising determining if a bid response is to be provided to said advertisement campaign in response to said determining if one or more data values of said request satisfies one or more of said sets of filters and if so to output a bid response.

15. The computer implemented method of claim 14, comprising associating said bid response with one of said sets of filters.

16. The computer implemented method of claim 12, wherein said hierarchy of filters is configured to provide for each filter a pass branch and a fail branch, wherein each of said pass branch and fail branch is associated with either a filter or a number of said sets, wherein said number comprises an integer.

17. The computer implemented method of claim 12, wherein said hierarchy of filters is configured represent a tree structure, with respective filters defining nodes and one or more sets of data defining leaf nodes.

18. The computer implemented method of claim 12, wherein said hierarchy of filters is such that a respective filter is provided a plurality of times and the at least one processor is configured such that only one of the respective filters is evaluated for a given request.

19. The computer implemented method of claim 18, wherein said hierarchy of filters has n or less layers, where n is the number of different filters.

20. A computer readable non-transitory storage medium carrying one or more sequences of instructions which when run on at least one processor cause the process to perform the following steps:
receive a request, the request comprising one or more data values; and
use data defining a hierarchy of filters to determine if said one or more data values of said request satisfy one or more of said sets of filters, said hierarchy of filters defining a plurality of different sets of filters, at least one of said filters in said hierarchy being shared by at least two of said sets and at least one filter being associated with at least two lower filters.
